(19) United States
(12) Patent Application Publication
(10) Pub. No.: US 2010/0203183 A1
(43) Pub. Date: Aug. 12, 2010

(54) ROLLER TYPE STAMPER

(76) Inventors: Chan-Iek Choi, Yongin-city (KR); Won-Ki Cho, Yongin-city (KR)

Correspondence Address: CHRISTIE, PARKER & HALE, LLP, PO BOX 7068, PASADENA, CA, 91109-7068, US

(21) Appl. No.: 12/698,983

(22) Filed: Feb. 2, 2010

(30) Foreign Application Priority Data
Feb. 9, 2009 (KR) 10-2009-0010141

(51) Int. Cl. B28B 5/10; B28B 3/16

(52) U.S. Cl. 425/363

(57) ABSTRACT

A roller type stamper includes a roller; a stamper film including a first surface having a pattern, and a second surface opposite the first surface and connected to an outer circumferential surface of the roller at least one connecting portion; and a planarizing portion for filling a groove approximate the at least one connecting portion.

### CROSS-REFERENCE TO RELATED APPLICATIONS

This application claims priority to and the benefit of Korean Patent Application No. 10-2009-0010141, filed on Feb. 9, 2009, in the Korean Intellectual Property Office, the entire content of which is incorporated herein by reference.

### BACKGROUND OF THE INVENTION

1. Field of the Invention

The present invention relates to a roller type stamper.

2. Description of Related Art

A liquid crystal display device is a non-emissive device in which a display panel for displaying images is not self-luminescent. Therefore, a separate backlight unit is required to supply light to the display panel.

The backlight unit includes a light source for emitting light, and optical plates, such as a light guide plate and a diffusion plate, which improve the efficiency of light emitted from the light source.

Accordingly, patterns having specific shapes such as prisms or hemispheres may be formed on the optical plates so as to improve light emission characteristics. An injection method is generally used as a method of forming the aforementioned patterns on the optical plates.

The injection method is a method of injecting a melted resin into a transfer mold having patterns formed therein.

However, in the injection method, a transfer rate is lowered when micro-patterns of several tens of micrometers (μm) are formed, and a pressure at which resin is injected is therefore limited. Therefore, it is difficult to manufacture optical plates and the like having a large size of, for example, over 17 inches, and mass production is hindered.

### SUMMARY OF THE INVENTION

In exemplary embodiments of the present invention, optical plates provided in a backlight unit are formed using a roll-to-roll method for improving a rate of manufacturing the backlight unit.

Accordingly, exemplary embodiments of the present invention provide a roller type stamper, wherein a micro groove formed when a stamper film having a predetermined pattern is connected to a roller may be filled using a silicon material or similar material, thereby removing the groove.

According to an aspect of an exemplary embodiment of the present invention, there is provided a roller type stamper including a roller; a stamper film including a first surface having a pattern, and a second surface opposite the first surface and connected to an outer circumferential surface of the roller at least one connecting portion; and a planarizing portion for filling a groove approximate the at least one connecting portion.

The planarizing portion may include silicon or a silicon compound and fluorine.

According to an aspect of another exemplary embodiment of the present invention, there is provided an apparatus for manufacturing an optical plate including a polycarbonate film, the apparatus including at least one layer forming unit for forming a layer on the polycarbonate film, the at least one layer forming unit including: a supply unit for supplying a material on the polycarbonate film; a set of rollers for forming patterns on the material; and a curing unit for curing the material including the formed patterns to form the layer; wherein the set of rollers includes a roller type stamper including: a roller; a stamper film including a first surface having a corresponding pattern to the patterns formed on the material, and a second surface opposite the first surface and connected to an outer circumferential surface of the roller at least one connecting portion; and a planarizing portion for filling a groove approximate the at least one connecting portion.

In a roller type stamper according to exemplary embodiments of the present invention, a silicon material is used as a finishing material along the connecting portion, the silicon material having strong adhesion to metal and excellent release characteristics from optical resin, thereby preventing or reducing defects in the optical resin generated by a groove at the connecting portion, such that a resin coating layer is not formed to be thicker in regions coming into contact with the connecting portion.

### BRIEF DESCRIPTION OF THE DRAWINGS

The accompanying drawings, together with the specification, illustrate exemplary embodiments of the present invention, and, together with the description, serve to explain the principles of embodiments of the present invention.

FIG. 1 is a schematic cross-sectional view of an optical plate according to an embodiment of the present invention.

FIG. 2 is a block diagram schematically showing an apparatus for manufacturing an optical plate according to an embodiment of the present invention.

FIG. 3 is a perspective view showing the shape of a roller type stamper according to an embodiment of the present invention.

FIG. 4 is an enlarged view of a portion of FIG. 3.

### DETAILED DESCRIPTION OF EXEMPLARY EMBODIMENTS

In the following detailed description, only certain exemplary embodiments of the present invention have been shown and described by way of illustration. As those skilled in the art would realize, the described embodiments may be modified in various different ways without departing from the spirit or scope of the present invention. Accordingly, the drawings and description are to be regarded as illustrative in nature and not restrictive. In addition, when an element is referred to as being “on” another element, it may be directly on the another element, or may be indirectly on the another element, with one or more elements interposed therebetween. Also, when an element is referred to as being “connected to” another element, it may be directly connected to the another element, or may be indirectly connected to the another element, with one or more elements connected therebetween. Hereinafter, like reference numerals refer to like elements.

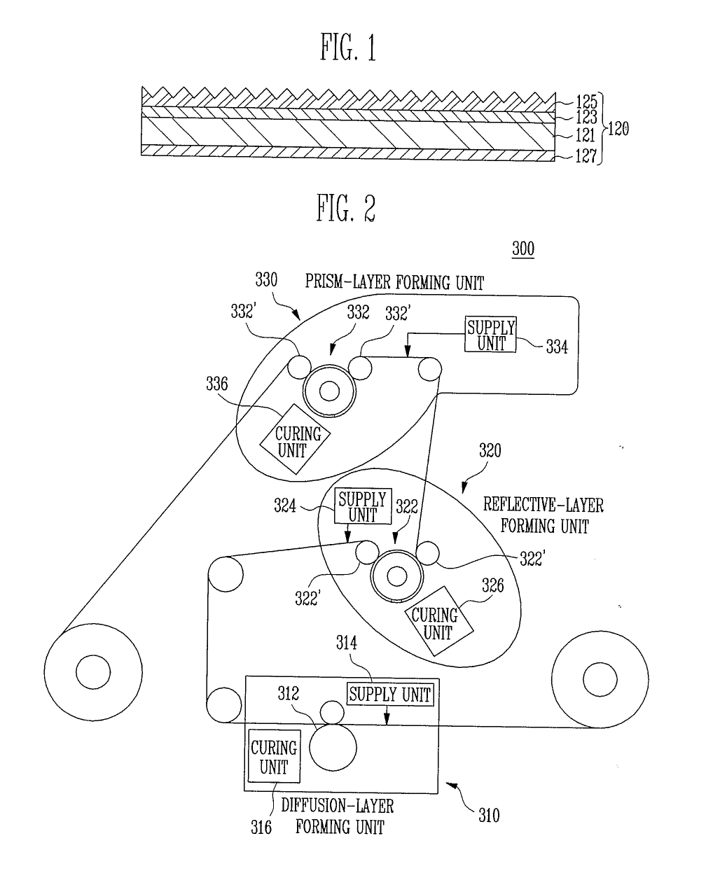

FIG. 1 is a cross-sectional view of an optical plate according to an embodiment of the present invention.

In FIG. 1, a light guide plate having regular patterns is described as an example of an optical plate provided in a liquid crystal display device. However, the optical plate according to the embodiment of the present invention is not limited thereto.

Referring to FIG. 1, the light guide plate 120 according to the embodiment of the present invention includes a polycarbonate (PC) film 121 formed to be flexible by adding a plasticizer to a PC material; a diffusion layer 123 formed on a first surface of the PC film 121; a prism layer 125 formed on the diffusion layer 123; and a reflective layer 127 formed on a second surface of the PC film 121 opposite the first surface.

In the described embodiment, the diffusion layer 123, the prism layer 125 and the reflective layer 127 may be individually formed through a coating process using a roll-to-roll method.

When the light guide plate 120 according to the embodiment of the present invention is provided in a backlight unit, an additional reflective sheet formed on the lower surface of the light guide plate 120 and an additional optical sheet formed on the upper surface of the light guide plate 120 may not be needed. Accordingly, the thickness of the backlight unit can be decreased.

Hereinafter, the configuration of an apparatus for manufacturing the light guide plate according to the embodiment of the present invention will be schematically described with reference to FIG. 2.

FIG. 2 is a block diagram schematically showing an apparatus for manufacturing an optical plate according to an embodiment of the present invention.

Referring to FIG. 2, in an apparatus 300, a PC film, for example, PC film 121 of FIG. 1 described above, is supplied. Accordingly, the light guide plate 120 is manufactured by coating a diffusion layer 123 on a first surface of the PC film 121, coating a reflective layer 127 on a second surface of the PC film 121 opposite the first surface, and then coating a prism layer 125 on the diffusion layer 123.

The apparatus 300 for manufacturing the light guide plate includes a diffusion-layer forming unit 310 for coating a diffusion layer on the first surface of the PC film 121; a reflective-layer forming unit 320 for coating a reflective layer on the second surface of the PC film 121; and a prism-layer forming unit 330 for coating a prism layer on the diffusion layer formed on the first surface of the PC film 121.

At this time, the diffusion-layer forming unit 310 includes a set of guide rollers 312 for guiding the PC film 121 provided by a winder and an unwinder; a supply unit 314 for supplying a diffusion material (e.g., resin) corresponding to a diffusion layer to be coated on the first surface of the PC film 121; and a curing unit 316 for curing the diffusion material formed on the first surface of the PC film 121, thereby forming the diffusion layer.

The diffusion layer is formed on the first surface of the PC film by the diffusion-layer forming unit 310. Subsequently, the PC film is introduced into the reflective-layer forming unit 320.

The reflective-layer forming unit 320 includes a supply unit 324 for supplying a reflective material (resin) corresponding to a reflective layer to be coated on the second surface of the PC film 121; a set of rollers 322 and 322′ for forming patterns on the reflective material and having patterns corresponding to the predetermined patterns; and a curing unit 326 for curing the reflective material with the predetermined patterns formed on the second surface of the PC film 121, thereby forming the reflective layer. Accordingly, the reflective layer is formed on the second surface of the PC film 121 having the diffusion layer formed on the first surface thereof.

The prism-layer forming unit 330 includes a supply unit 334 for supplying a material (resin) corresponding to a prism layer to be coated on the diffusion layer formed on the PC film 121; a set of rollers 332 and 332′ for forming prism patterns on the material and having patterns corresponding to the prism patterns; and a curing unit 336 for curing the material with the prism patterns formed on the diffusion layer formed on the first surface of the PC film 121, thereby forming the prism layer. Accordingly, the light guide film 120 according to the embodiment of the present invention shown in FIG. 1 is manufactured.

When patterns (e.g., predetermined reflective and prism patterns) are respectively formed on the set of rollers 322 and 322′ provided in the reflective-layer forming unit 320 and the set of rollers 332 and 332′ provided in the prism-layer forming unit 330, the roller type stampers 322 and 332 according to an embodiment of the present invention may be utilized in the apparatus 300 for manufacturing the optical plate.

The set of rollers 322 and 322′ include a roller type stamper 322 to which a stamper film having reflective patterns (e.g., predetermined reflective patterns) formed thereon is fastened and a pair of guide rolls 322′ for guiding the PC film 121 along the roller type stamper 322.

Likewise, the set of rollers 332 and 332′ include a roller type stamper 332 to which a stamper film having prism patterns (e.g., predetermined prism patterns) formed thereon is fastened and a pair of guide rolls 332′ for guiding the PC film 121 along the roller type stamper 332.

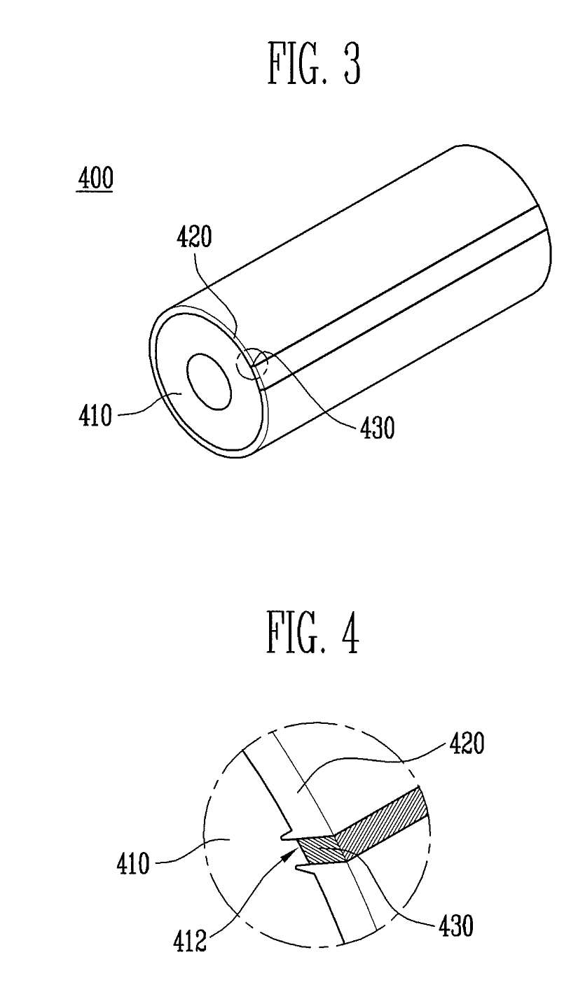

FIG. 3 is a perspective view showing the shape of a roller type stamper according to an embodiment of the present invention. FIG. 4 is an enlarged view of a portion of FIG. 3, i.e., a connecting and planarizing portion.

Referring to FIGS. 3 and 4, the roller type stamper 400 according to the embodiment of the present invention includes a roller 410; a stamper film 420 having a pattern (e.g., a predetermined pattern) formed on a first surface thereof, and having a second surface connected to an outer circumferential surface of the roller 410 through at least one connecting portion 412 provided to the roller 410; and a planarizing portion 430 planarizing a groove region formed approximate the connecting portion 412.

That is, when an optical plate is manufactured using rollers as described in the apparatus for manufacturing the optical plate shown in FIG. 2, a planarizing portion 430 is formed in a micro groove, i.e., a region of the connecting portion 412, formed when the stamper film 420 is connected to the roller 410. Accordingly, the groove of the connecting portion 412 is filled.

In the described embodiment, the roller 410 may be formed of a metallic material. In this case, metal is exposed at a lower portion of the micro groove formed at the connecting portion 412.

Accordingly, the planarizing portion 430, in one embodiment, is formed of a silicon material having strong adhesion to the metal.

The silicon material has excellent release characteristics from (i.e., low adhesion to) a material (i.e., resin) having a pattern (e.g., a predetermined pattern) formed by the roller type stamper 400 as described with reference to FIG. 2. Accordingly, defects generated when corresponding patterns are being formed on the resin can be minimized or reduced.

Further, the planarizing portion 430 in one embodiment is formed of a silicon compound material prepared by adding fluorine to the silicon material, so as to improve the release characteristics from the resin.

As described above, in the roller type stamper 400 according to the embodiment of the present invention, a silicon material having strong adhesion with metal and excellent release rate from optical resin, or a silicon compound material added with fluorine, is utilized to form the planarizing portion 430, i.e., as a finishing or filler material along the connecting portion 412 of the roller 410, thereby preventing or reducing potential defects in the optical resin generated by a groove at the connecting portion 412. Therefore a resin coating layer is not formed to be thicker in the regions that come into contact with the connecting portion 412.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A roller type stamper comprising:
a roller;
a stamper film comprising a first surface having a pattern, and a second surface opposite the first surface and connected to an outer circumferential surface of the roller at least one connecting portion; and
a planarizing portion for filling a groove approximate the at least one connecting portion.

2. The roller type stamper of claim 1, wherein the planarizing portion comprises silicon.

3. The roller type stamper of claim 1, wherein the planarizing portion comprises a silicon compound and fluorine.

4. The roller type stamper of claim 1, wherein the groove is formed along the at least one connecting portion where the stamper film is connected to the roller.

5. The roller type stamper of claim 1, wherein the pattern is for forming corresponding patterns on a reflective layer of an optical plate.

6. The roller type stamper of claim 1, wherein the pattern is for forming corresponding patterns on a prism layer of an optical plate.

7. An apparatus for manufacturing an optical plate comprising a polycarbonate film, the apparatus comprising at least one layer forming unit for forming a layer on the polycarbonate film, the at least one layer forming unit comprising:
a supply unit for supplying a material on the polycarbonate film;
a set of rollers for forming patterns on the material; and
a curing unit for curing the material including the formed patterns to form the layer;
wherein the set of rollers comprises a roller type stamper comprising:
a roller;
a stamper film comprising a first surface having a corresponding pattern to the patterns formed on the material, and a second surface opposite the first surface and connected to an outer circumferential surface of the roller at least one connecting portion; and
a planarizing portion for filling a groove approximate the at least one connecting portion.

8. The apparatus of claim 7, wherein the planarizing portion comprises silicon.

9. The apparatus of claim 7, where the planarizing portion comprises a silicon compound and fluorine.

10. The apparatus of claim 7, wherein the planarizing portion comprises a material that has low adhesion to the material.

11. The apparatus of claim 7, wherein the groove is formed along the at least one connecting portion where the stamper film is connected to the roller.

12. The apparatus of claim 7, wherein one of the at least one layer forming unit is a reflective layer forming unit, and wherein the corresponding pattern of the stamper film is for forming the patterns on the material to form a reflective layer.

13. The apparatus of claim 7, wherein one of the at least one layer forming unit is a prism layer forming unit, and wherein the corresponding pattern of the stamper film is for forming the patterns on the material to form a prism layer.

14. The apparatus of claim 7, further comprising a diffusion layer forming unit for forming a diffusion layer on the polycarbonate film, the diffusion layer forming unit comprising:
a supply unit for supplying a diffusion material on the polycarbonate film;
a set of rollers for guiding the polycarbonate film including the diffusion material; and
a curing unit for curing the diffusion material to form the diffusion layer.

15. The apparatus of claim 7, wherein the at least one layer forming unit comprises a prism layer forming unit for forming a prism layer on a first surface of the polycarbonate film, and a reflective layer forming unit for forming a reflective layer on a second surface of the polycarbonate film opposite the first surface, and wherein the apparatus further comprises a diffusion layer forming unit for forming a diffusion layer between the first surface of the polycarbonate film and the prism layer.
